(19) United States
(12) Patent Application Publication
(10) Pub. No.: US 2024/0206002 A1
(43) Pub. Date: Jun. 20, 2024

(54) A METHOD, A USER EQUIPMENT, A NETWORK NODE AND A COMPUTER-READABLE NON-TRANSITORY STORAGE MEDIUM

(71) Applicant: NEC Corporation, Minato-ku, Tokyo (JP)

(72) Inventors: Chadi KHIRALLAH, Epsom (GB); Yuhua CHEN, London (GB); Sadafuku HAYASHI, Tokyo (JP)

(73) Assignee: NEC Corporation, Minato-ku, Tokyo (JP)

(21) Appl. No.: 18/285,717

(22) PCT Filed: Apr. 12, 2022
(86) PCT No.: PCT/JP2022/017603

§ 371 Date: Oct. 5, 2023

(30) Foreign Application Priority Data
Apr. 15, 2021 (GB) 2105402.8
May 6, 2021 (GB) 2106477.9

(51) Int. Cl. H04W 76/27; H04W 48/18; H04W 76/34; H04W 84/06

(52) U.S. Cl. CPC H04W 76/27; H04W 48/18; H04W 76/34; H04W 84/06

(57) ABSTRACT

The present invention provides methods and associated apparatus that address or at least alleviate the issues of a user equipment (UE) context when the UE moves from one geographical area to another geographical area. A communication system (1) is disclosed that includes a non-terrestrial network portion comprising a plurality of cells each cell serving at least one coverage area. A UE (3) has a Radio Resource Control (RRC) connection in a first coverage area. When the UE (3) detects, based on location information, that it has moved to a different coverage area it releases the RRC connection based on the location of the UE (3).

### TECHNICAL FIELD

The present invention relates to a wireless communication system and devices thereof operating according to the 3rd Generation Partnership Project (3GPP) standards or equivalents or derivatives thereof. The disclosure has particular but not exclusive relevance to improvements relating to UE context retrieval/UE redirection in the so-called ‘5G’ (or ‘Next Generation’) systems employing a non-terrestrial portion comprising airborne or spaceborne network nodes.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect IoT devices and similar MTC devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IOT)/Industrial Internet of Things (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.4.0 and TS 37.340 V16.4.0 define the following nodes, amongst others:

gNB: node providing NR user plane and control plane protocol terminations towards the UE, and connected via the NG interface to the 5G core network (5GC).

ng-eNB: node providing Evolved Universal Terrestrial Radio Access (E-UTRA) user plane and control plane protocol terminations towards the UE, and connected via the NG interface to the 5GC.

en-gNB: node providing NR user plane and control plane protocol terminations towards the UE, and acting as Secondary Node in E-UTRA-NR Dual Connectivity (EN-DC).

NG-RAN node: either a gNB or an ng-eNB.

3GPP is also working on specifying an integrated satellite and terrestrial network infrastructure in the context of 5G. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS—all operating quasi-stationary at an altitude typically between 8 and 50 km.

### CITATION LIST

### Non Patent Literature

NPL 1: 3GPP Technical Report 38.811 V15.4.0
NPL 2: 3GPP Technical Report 38.821 V16.0.0

NPL 1 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). NPL 2 provides further details about NTN.

Non-Terrestrial Networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.

NTN access typically features the following elements (amongst others):
NTN Terminal: It may refer to a 3GPP UE or a terminal specific to the satellite system in case the satellite doesn't serve directly 3GPP UEs.
A service link which refer to the radio link between the user equipment and the space/airborne platform (which may be in addition to a radio link with a terrestrial based RAN).
A space or an airborne platform.
Gateways (‘NTN Gateways’) that connect the satellite or aerial access network to the core network. It will be appreciated that gateways will mostly likely be co-located with a base station.
Feeder links which refer to the radio links between the gateways and the space/airborne platform.

Satellite or aerial vehicles may generate several beams over a given area to provide respective NTN cells. The beams have a typically elliptic footprint on the surface of the Earth.

3GPP intends to support three types of NTN beams or cells:
I Earth-fixed cells characterized by at least one beam covering the same geographical areas all the time (e.g. GEO satellites and HAPS);
quasi-Earth-fixed cells characterized by at least one beam covering one geographic area for a finite period and a different geographic area during another period (e.g. NGEO satellites generating steerable beams); and
Earth-moving cells characterized by at least one beam covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

LEO satellites may have steerable beams in which case the beams are temporarily directed to substantially fixed footprints on the Earth. In other words, the beam footprints (which represent NTN cell) are stationary on the ground for a certain amount of time before they change their focus area over to another NTN cell (due to the satellite's movement on its orbit). From cell coverage/UE point of view, this results in cell changes happening regularly at discrete intervals because different Physical Cell Identities (PCIs) and/or Synchronization Signal/Physical Broadcast Channel (PBCH) blocks (SSBs) have to be assigned after each service link change, even when these beams serve the same land area (have the same footprint). LEO satellites without steerable beams cause the beams (cells) moving on the ground constantly in a sweeping motion as the satellite moves along its orbit and as in the case of steerable beams, service link change and consequently cell changes happen regularly at discrete intervals.

Similarly to service link changes, feeder link changes also happen at regular intervals due to the satellite's movement on its orbit. Both service and feeder link changes may be performed between different base stations/gateways (which may be referred to as an ‘inter-gNB radio link switch’) or within the same base station/gateway (‘intra-gNB radio link switch’). 3GPP is still working on the detailed specifications, however, it is assumed that Earth fixed tracking areas will be used with Earth fixed and/or moving cells.

Groups of cells are allocated to different coverage areas or service/tracking areas which may correspond to respective geographical areas (such as a country, a city, a region, or any similar geographical unit). Each cell has an associated ‘NR Cell Global Identifier’ (NCGI) which is constructed from the Public Land Mobile Network (PLMN) identity (PLMN ID) the cell belongs to and the NR Cell Identity (NCI) of the cell. The ‘Global gNB ID’ is used to identify a gNB globally and it is constructed from the PLMN identity the gNB belongs to and a gNB ID (which is an identifier for identifying a particular gNB within a PLMN). However, it is not precluded that a cell served by a gNB does not broadcast the associated PLMN ID included in the Global gNB ID.

A base station (gNB/NG-RAN node) may control one or more cells serving different geographical areas (e.g. different coverage areas, service areas, tracking areas, or countries). The base station may serve more than one of such geographical areas via a single cell having coverage (a cell footprint) across a border between neighbouring areas. The base station may also serve multiple geographical areas via respective cells (i.e. a cell may serve a single area only). If the base station serves more than one geographical area, the base station ensures that each UE is using an Access and Mobility Management Function (AMF) that serves the geographical area in which that UE is located (by taking into account UE location information, if available).

### SUMMARY OF INVENTION

### Technical Problem

A UE may initially establish a Radio Resource Control (RRC) connection via a cell and register with an AMF in one geographical area (e.g. in a first country). Subsequently, the UE may move to a different geographical area (e.g. in a second country). This may happen for example when the UE moves across the border (e.g. within the same cell).

However, the earlier UE context is not suitable for that region and cannot be used by the base station serving the UE in the new area.

Accordingly, the present invention seeks to provide methods and associated apparatus that address or at least alleviate (at least some of) the above described issues.

Although for efficiency of understanding for those of skill in the art, the invention will be described in detail in the context of a 3GPP system (5G networks including NTN), the principles of the invention can be applied to other systems as well.

### Solution to Problem

In one example aspect, the invention provides a method performed by a user equipment (UE) configured to communicate via a non-terrestrial network comprising a plurality of cells, wherein the UE has a Radio Resource Control (RRC) connection related to a first coverage area, the method comprising: determining that a current location of the UE is in a different coverage area to the first coverage area; and releasing the RRC connection based on the current location of the UE.

In one example aspect, the invention provides a method performed by a network node configured to communicate with a user equipment (UE) via a non-terrestrial network comprising a plurality of cells, wherein the UE has a Radio Resource Control (RRC) connection related to a first coverage area, the method comprising: receiving, from the UE, a message initiating a procedure for releasing the RRC connection based on the current location of the UE; and transmitting, to the UE, a message releasing the RRC connection based on the location of the UE.

In one example aspect, the invention provides a user equipment (UE) configured to communicate via a non-terrestrial network comprising a plurality of cells, wherein the UE has a Radio Resource Control (RRC) connection related to a first coverage area, the UE comprising: means for determining that a current location of the UE is in a different coverage area to the first coverage area; and means for releasing the RRC connection based on the current location of the UE.

In one example aspect, the invention provides a network node configured to communicate with a user equipment (UE) via a non-terrestrial network comprising a plurality of cells, wherein the UE has a Radio Resource Control (RRC) connection related to a first coverage area, the network node comprising: means for receiving, from the UE, a message initiating a procedure for releasing the RRC connection based on the current location of the UE; and means for transmitting, to the UE, a message releasing the RRC connection based on the location of the UE.

In another example aspect, the invention provides a user equipment (UE) configured to communicate via a non-terrestrial network comprising a plurality of cells, wherein the UE has a Radio Resource Control (RRC) connection related to a first coverage area, the UE comprising a processor, a transceiver, and a memory storing instructions; wherein the controller is configured to: determine that a current location of the UE is in a different coverage area to the first coverage area; and release the RRC connection based on the current location of the UE.

In another example aspect, the invention provides a network node configured to communicate with a user equipment (UE) via a non-terrestrial network comprising a plurality of cells, wherein the UE has a Radio Resource Control (RRC) connection related to a first coverage area, the network node comprising a processor, a transceiver, and a memory storing instructions; wherein the controller is configured to control the transceiver to: receive, from the UE, a message initiating a procedure for releasing the RRC connection based on the current location of the UE; and transmit, to the UE, a message releasing the RRC connection based on the location of the UE.

Aspects of the invention extend to corresponding systems, apparatus, and computer program products such as computer readable storage media having instructions stored thereon which are operable to program a programmable processor to carry out a method as described in the example aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### Advantageous Effects of Invention

The present invention provides methods and associated apparatus that address or at least alleviate (at least some of) the above described issues.

### BRIEF DESCRIPTION OF DRAWINGS

Embodiments of the invention will now be described, by way of example, with reference to the accompanying drawings.

FIG. 1 illustrates schematically a mobile (cellular or wireless) telecommunication system to which example embodiments of the invention may be applied.

FIG. 2 is a schematic block diagram of a mobile device forming part of the system shown in FIG. 1.

FIG. 3 is a schematic block diagram of an NTN node (e.g. satellite/UAS platform) forming part of the system shown in FIG. 1.

FIG. 4 is a schematic block diagram of an access network node (e.g. base station) forming part of the system shown in FIG. 1.

FIG. 5 illustrates schematically two exemplary scenarios to which example embodiments of the present invention may be applied.

FIG. 6 illustrates schematically two exemplary scenarios to which example embodiments of the present invention may be applied.

FIG. 7 is signalling (timing) diagrams illustrating some exemplary ways in which example embodiments of the present invention may be performed in the scenarios shown in FIGS. 5 and 6.

FIG. 8 is signalling (timing) diagrams illustrating some exemplary ways in which example embodiments of the present invention may be performed in the scenarios shown in FIGS. 5 and 6.

FIG. 9 is signalling (timing) diagrams illustrating some exemplary ways in which example embodiments of the present invention may be performed in the scenarios shown in FIGS. 5 and 6.

FIG. 10 is signalling (timing) diagrams illustrating some exemplary ways in which example embodiments of the present invention may be performed in the scenarios shown in FIGS. 5 and 6.

FIG. 11 is signalling (timing) diagrams illustrating some exemplary ways in which example embodiments of the present invention may be performed in the scenarios shown in FIGS. 5 and 6.

FIG. 12 illustrates schematically some exemplary architecture options for the provision of NTN features in the system shown in FIG. 1.

### DESCRIPTION OF EMBODIMENTS

### Overview

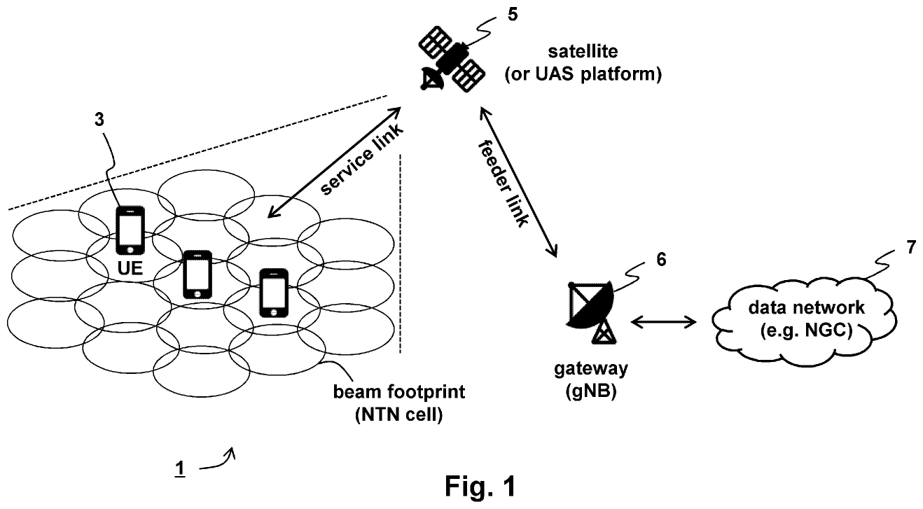

FIG. 1 illustrates schematically a mobile (cellular or wireless) telecommunication system 1 to which example embodiments of the invention may be applied.

In this system 1, users of mobile devices 3 (UEs) can communicate with each other and other users via access network nodes respective satellites 5 and/or base stations 6 and a data network 7 using an appropriate 3GPP radio access technology (RAT), for example, an E-UTRA and/or 5G RAT. As those skilled in the art will appreciate, whilst three mobile devices 3, one satellite 5, and one base station 6 are shown in FIG. 1 for illustration purposes, the system, when implemented, will typically include other satellites/UAS platforms, base stations/RAN nodes, and mobile devices (UEs).

It will be appreciated that a number of base stations 6 form a (radio) access network or (R)AN, and a number of NTN nodes 5 (satellites and/or UAS platforms) form a Non-Terrestrial Network (NTN). Each NTN node 5 is connected to an appropriate gateway (in this case co-located with a base station 6) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R)AN, although it may also provide satellite communication services independently of E-UTRA and/or 5G communication services.

Although not shown in FIG. 1, neighbouring base stations 6 are connected to each other via an appropriate base station to base station interface (such as the so-called ‘X2’ interface, ‘Xn’ interface and/or the like). The base station 6 is also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the data network 7 of a ‘Next Generation’/5G system will include user plane entities and control plane entities, such as one or more control plane functions (CPFs) and one or more user plane functions (UPFs). The so-called Access and Mobility Management Function (AMF) is responsible for handling connection and mobility management tasks for the mobile devices 3. The data network 7 is also coupled to other data networks such as the Internet or similar Internet Protocol (IP) based networks (not shown in FIG. 1).

Each NTN node 5 controls a number of directional beams via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 5 is travelling along its orbit. Alternatively, the beam footprint may be earth fixed, in which case an appropriate beam pointing mechanism (mechanical or electronic steering) may be used to compensate for the movement of the NTN node 5.

Each cell has an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

Cells serving a particular geographical area are grouped into a coverage area (e.g. a tracking area) that belongs to a PLMN. In this example different groups of cells serve different countries although other types of cell grouping are possible as well.

The UE 3 establishes an RRC connection with a base station 6 via a cell and registers with an appropriate AMF 9 in the country/area/PLMN that the base station 6 serves. Accordingly, the UE 3 is in the so-called RRC connected state and an associated UE context is maintained by the serving base station 6-1. If the UE 3 is subsequently released to RRC Inactive state, the RRC connection is suspended and the associated UE context is stored by the base station 6-1 (which may be referred to as the UE's last/old serving base station once the UE 3 is in the RRC Inactive state).

Whilst in the RRC connected state or in the RRC inactive state, the UE 3 might move to a different coverage area/country. It will be appreciated that this new coverage area/country may be a cell under the control of the same base station 6 or a different base station. The cell may broadcast its at least one associated PLMN ID although some cells are not configured to broadcast such IDs.

The UE 3 also may be configured to monitor (either in RRC connected state or in RRC inactive state) its current location and its current coverage area/country based on appropriate location information such as Global Navigation Satellite System (GNSS) location information, MCC (of the mobile device), and/or any other suitable positioning information. The current UE context associated with the UE 3 and/or the AMF 9 allocated to the UE 3 may not be suitable in the new coverage area or country. Therefore, when the UE 3 detects that it has moved to a different coverage area (new country) than the coverage area associated with its UE context/current AMF, the UE 3 is configured to release the RRC connection, either on its own or by initiating an appropriate procedure with the network. Effectively, by releasing the RRC connection the UE 3 enters the RRC Idle state (from the RRC Inactive or RRC Connected state).

If the UE 3 (e.g. in the RRC connected state) notifies the network that it needs to release its RRC connection due to a change in its coverage area, the base station may send the mobile device 3 appropriate redirection information for registering with a new AMF that is suitable for the coverage area/country/PLMN where the mobile device 3 is currently located.

### User Equipment (UE)

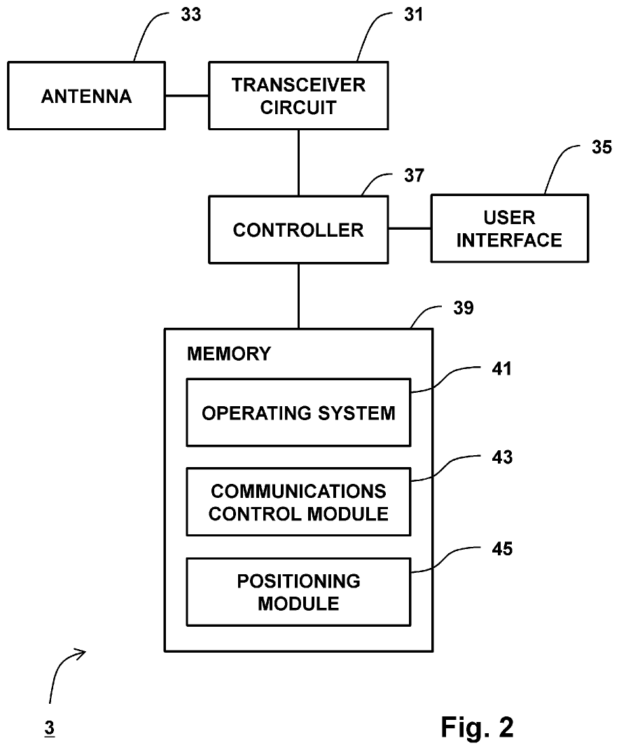

FIG. 2 is a block diagram illustrating the main components of the mobile device (UE) 3 shown in FIG. 1. As shown, the UE 3 includes a transceiver circuit 31 which is operable to transmit signals to and to receive signals from the at least one connected node via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and a positioning module 45.

The communications control module 43 is responsible for handling (generating/sending/receiving) signalling messages and uplink/downlink data packets between the UE 3 and other nodes, including NTN nodes 5, (R)AN nodes 6, and core network nodes. The signalling may comprise control signalling related to RRC setup, RRC (re)configuration, RRC resumption, RRC release, and/or redirection to a new AMF/PLMN.

The positioning module 45 (which is optional in some UEs) is responsible for determining the position of the UE 3, for example based on GNSS signals.

### NTN Node (Satellite/UAS Platform)

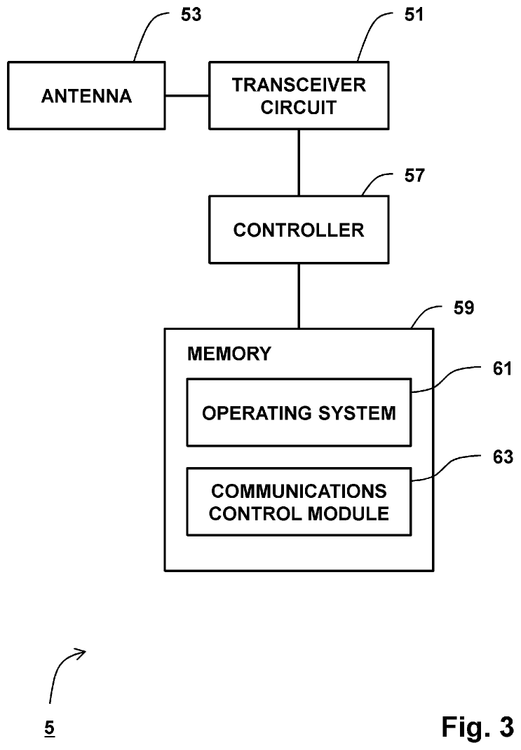

FIG. 3 is a block diagram illustrating the main components of the NTN node 5 (a satellite or a UAS platform) shown in FIG. 1. As shown, the NTN node 5 includes a transceiver circuit 51 which is operable to transmit signals to and to receive signals from at least one connected UE 3 via one or more antenna 53 and to transmit signals to and to receive signals from other network nodes such as gateways and base stations (either directly or indirectly). A controller 57 controls the operation of the NTN node 5 in accordance with software stored in a memory 59. The software may be pre-installed in the memory 59 and/or may be downloaded via the telecommunication network 1 or from a removable data storage device (RMD), for example. The software includes, among other things, an operating system 61, and a communications control module 63.

The communications control module 63 is responsible for handling (generating/sending/receiving) signalling between the NTN node 5 and other nodes, such as the UE 3, base stations 6, gateways, and core network nodes (via the base stations/gateways). The signalling may comprise control signalling related to RRC setup, RRC (re)configuration, RRC resumption, RRC release, and/or UE redirection to a new AMF/PLMN.

### Base Station/Gateway (Access Network Node)

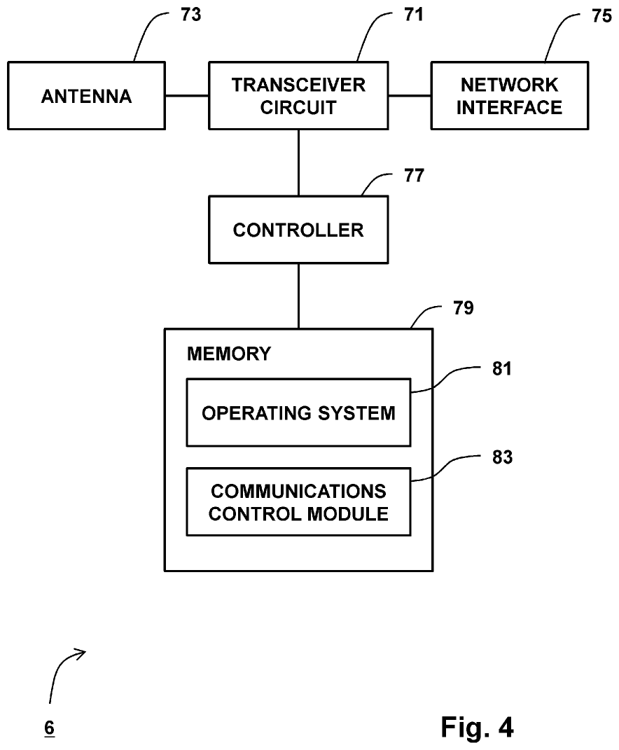

FIG. 4 is a block diagram illustrating the main components of the gateway 6 shown in FIG. 1 (a base station (gNB) or a similar access network node). As shown, the gateway/gNB 6 includes a transceiver circuit 71 which is operable to transmit signals to and to receive signals from at least one connected UE 3 via one or more antenna 73 and to transmit signals to and to receive signals from other network nodes (either directly or indirectly) via a network interface 75. Signals may be transmitted to and received from the at least one UE 3 either directly and/or via the NTN node 5, as appropriate. The network interface 75 typically includes an appropriate base station—base station interface (such as X2/Xn) and an appropriate base station—core network interface (such as S1/NG-C/NG-U). A controller 77 controls the operation of the base station 6 in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signalling between the base station 6 and other nodes, such as the UE 3, NTN nodes 5, and core network nodes. The signalling may comprise control signalling related to RRC setup, RRC (re)configuration, RRC resumption, RRC release, and/or UE redirection to a new AMF/PLMN.

### DETAILED DESCRIPTION

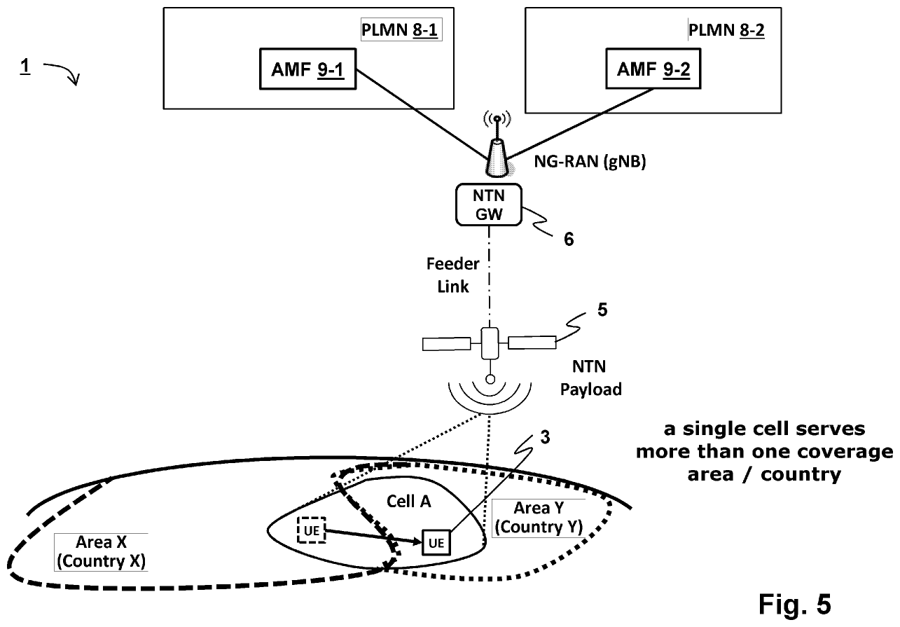

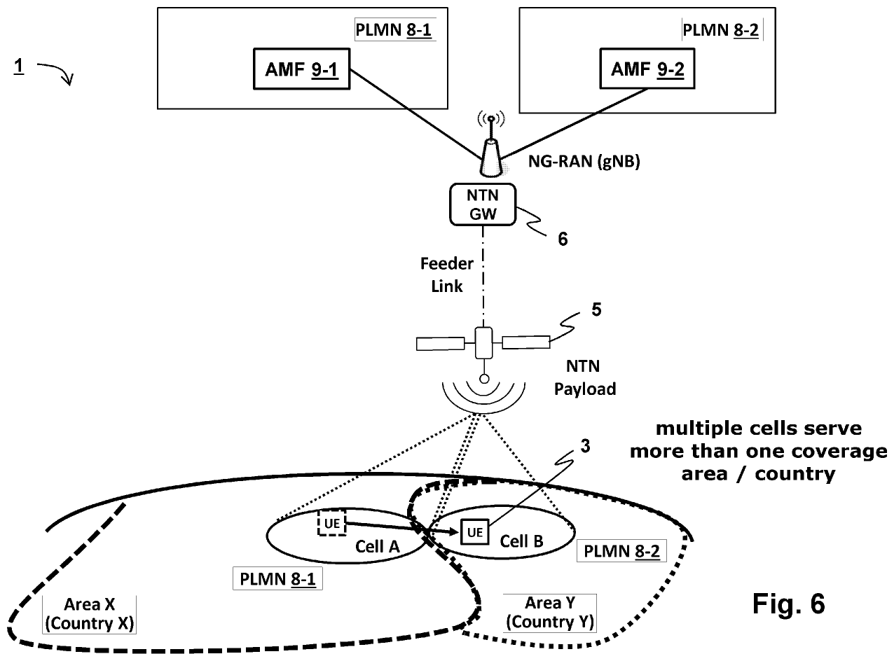

The following is a description of some exemplary procedures (Solutions 1 to 3) performed by the nodes of the system shown in FIG. 1, with reference to the scenarios shown in FIGS. 5 and 6.

Specifically, in the scenario shown in FIG. 5 the base station 6 (gNB) serves more than one country or more than one coverage area via its cell (‘Cell A’ in FIG. 5) and the cell broadcasts identifiers of the respective PLMNs associated with the countries or coverage areas served via that cell. In FIG. 6, the base station 6 controls cells in different countries or coverage areas, each cell broadcasting the at least one identifier of the at least one PLMN served by that cell. The base station 6 has connectivity to different AMFs 9-1 and 9-2 serving respective PLMNs 8-1 and 8-2 in different countries/areas.

In the above scenarios, the UE 3 establishes an RRC connection with a base station via a cell and registers with an AMF in the associated country/area/PLMN. In the examples shown in FIGS. 5 and 6, the UE 3 (initially) establishes an RRC connection via ‘Cell A’ of the base station 6 and registers with AMF 9-1 in ‘Coverage Area X’ or ‘Country X’ (PLMN 8-1). Thus, in this case the UE 3 is in the so-called RRC connected state and an associated UE context is maintained by the serving base station 6. If the UE 3 is subsequently released to RRC Inactive state, the RRC connection is suspended and the associated UE context is stored by the base station 6 (which may be referred to as the UE's last/old serving gNB once the UE is in the RRC Inactive state).

Later, in RRC Inactive or RRC Connected state, the UE 3 might move to another coverage area (within the same cell, as in FIG. 5, or in a new cell, as in FIG. 6). In this example, the cell that serves the new coverage are belongs to the same base station 6.

In order to avoid using an unsuitable UE context in the new country or new area, the nodes of this system are configured to perform one or more of the following solutions.

### Solution 1

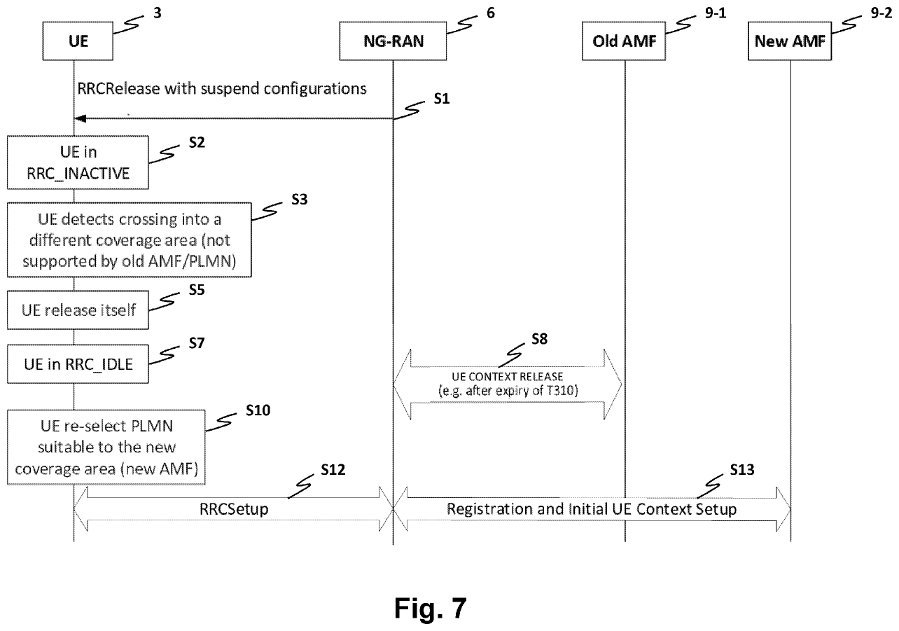

FIG. 7 is signalling (timing) diagram illustrating an exemplary way in which the UE may move to RRC Idle in the above scenarios.

Initially, the UE 3 might be in the RRC connected state in which UE 3 has an RRC connection with a base station 6 (e.g. a gNB of an NG-RAN). The UE 3 is registered with an AMF 9-1 (denoted ‘Old AMF’ in FIG. 7). The base station 6 and the AMF 7-1 serve the UE's current coverage area (e.g. ‘Country X’ in FIGS. 5 and 6).

In step S1 the serving base station 6 (RAN node) transmits appropriate parameters to the UE 3 for suspending the UE's RRC connection. In this example, the base station 6 generates and transmits an appropriately formatted ‘RRCRelease’ message to the UE 3 including the applicable suspend configuration.

Based on the received configuration, the UE 3 enters the RRC inactive state. An associated UE context is stored at the base station 6. The UE context is related to, or valid in, the coverage area (country) served by the AMF 9-1 that the UE 3 is currently registered with.

Whilst in the RRC Inactive state, the UE 3 monitors its location (e.g. by performing periodic location measurements, by monitoring signal conditions of nearby cells, and/or by monitoring system information transmitted in nearby cells). In this example, the UE 3 determines its current location using GNSS, MCC, and/or the like.

It will be appreciated that each cell of this system serves at least one coverage area/country. The cells of this system broadcast (e.g. in associated system information) information identifying the respective coverage areas/countries they serve (e.g. based on associated PLMNs and/or MCCs). This information may be a list of PLMN identifiers and associated MCCs.

Additionally, a cell may also broadcast, as part of the system information or via higher layers, information identifying/relating to a border of any at least one coverage area associated with that cell. This information may be provided as map data and/or the like. The UE 3 may be configured to detect whether the cell supports multiple coverage areas (countries) under the control of different PLMNs, based on the PLMN identifiers/MCC broadcast in the cell.

When the UE 3 detects (in step S3) that it has moved to a different coverage area (new country) than the coverage area served by the AMF 9-1 that the UE 3 is currently registered with, the UE 3 releases the RRC connection, as generally shown in step S5. As can be seen, in this case the UE 3 releases the RRC connection on its own and the UE 3 enters the RRC Idle state (step S7). It will be appreciated that the new coverage area may be served by the same cell as the old coverage area, i.e. the UE 3 may be in the same cell (e.g. in ‘Cell A’ in FIG. 5).

On the network side, due to the UE 3 being in RRC Idle state (which means that the UE does not resume the RRC connection within a predetermined time and does not provide a location update), the serving base station 6 and the old serving AMF 9-1 perform an appropriate UE Context Release procedure (step S8) to remove the obsolete UE context and free up resources at the base station 6. For example, the UE context stored in the network may be released after the expiry of an appropriate timer (e.g. a ‘T310’ timer, the value of which is given by the PeriodicRNAU-TimerValue information element, or any suitable timer).

### Solution 2

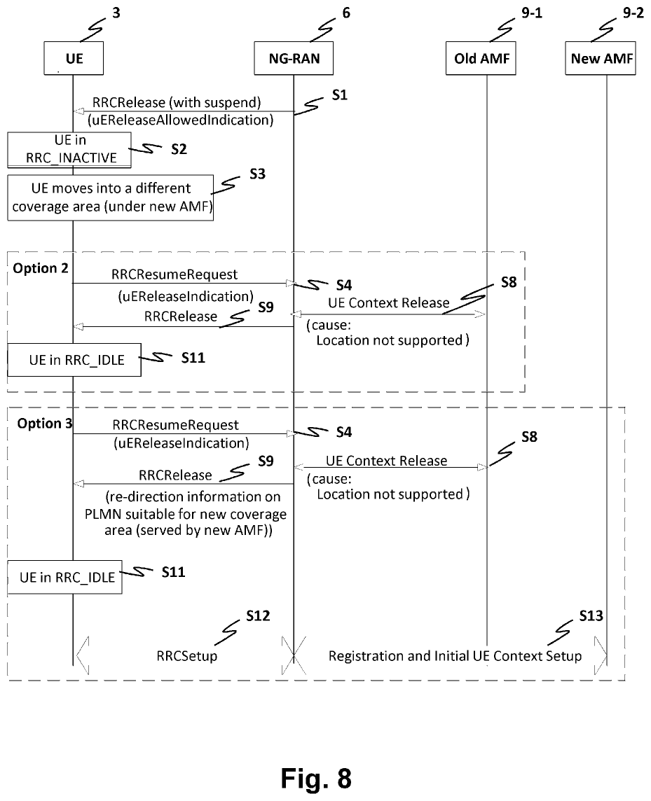

A first option of Solution 2 is based on steps S1 to S7 described above with reference to FIG. 7, whilst a second and a third option are illustrated in FIG. 8.

In the first option, after the UE 3 has released the RRC connection (in step S5), it determines which PLMN to use in the current coverage area (step S10), if any. The UE 3 selects the appropriate PLMN and proceeds to register with a new AMF 9-2 associated with the coverage area (or country) where the UE 3 is currently located.

In more detail, the UE 3 selects a suitable PLMN based on information held at the UE 3 (e.g. a list of PLMNs and corresponding coverage areas). The newly selected PLMN is served by a new AMF 9-2, thus the UE 3 performs an appropriate RRC setup procedure in the new coverage area (via a serving base station 6) and registers with the new AMF 9-2, as generally shown in steps S12 and S13 of FIG. 7. It will be appreciated that in this case a UE Context Release procedure with the base station 6 may be performed after (or in response to) the RRC setup (step S12) or the registration of the UE 3 with the new AMF 9-2. In other words, step S8 may be performed after step S12/S13 regardless of whether an associated timer (e.g. a T310 timer) is still running at the base station 6/old AMF 9-1. The UE Context Release procedure may be initiated by the base station 6 or the new AMF 9-2 towards the old AMF 9-1 (or the old serving base station 6, if different).

FIG. 8 is a signalling (timing) diagram schematically illustrating two options (options 2 and 3) for moving the UE to RRC Idle and subsequently registering with a new AMF.

In the second option, the serving RAN node 6 indicates to the UE 3 whether it is allowed to release the RRC connection by itself upon moving into a new coverage area/country different to the one where the UE 3 was previously registered. In this example, the indication is transmitted in the RRCRelease message (step S1) that includes the suspend configuration parameters although any other suitable message may be used (any suitable RRC message, system information block, and/or the like).

In step S1, the serving base station 6 sets the applicable UE release configuration using one or more appropriate information elements (IEs) to allow the UE 3 to release itself once it moves into (crosses the border of) a new coverage area, different to the one where the UE 3 was previously registered. For example, the RRCRelease message may include the UE release configuration (e.g. uEReleaseAllowedIndication IE, uEReleaseLocationIndication IE, and/or the like) indicating whether the UE 3 is allowed to release the RRC connection. The information elements may have a ‘TRUE’/‘FALSE’ value (or ‘1’/‘0’) depending on the applicable configuration, e.g. set to ‘TRUE’/‘1’ when the UE 3 is allowed to release the RRC connection and set to ‘FALSE’/‘0’ otherwise.

For example, the RRCRelease message (specified in 3GPP TS 38.331) may be adapted to include the following information elements:

RRCRelease-vxyz-IEs ::= SEQUENCE {
uEReleaseAllowedIndication ENUMERATED {true} OPTIONAL, --
Need N
nonCriticalExtension SEQUENCE { } OPTIONAL
}

The uEReleaseLocationIndication field (if present) may be defined as a field that indicates to the UE to trigger RRC release (i.e. release itself to RRC IDLE) in a case that this UE moves to a new coverage area, which is under control of a new AMF different to the AMF that the UE performed registration with.

In step S2 the UE 3 enters the RRC inactive state and monitors its location (at least on a coverage area level). If the UE 3 determines (in step S3), based on its location information, and/or information identifying/relating to a border of any at least one coverage area associated with that cell, that it has moved to a different coverage area (new country) than the coverage area served by the AMF 9-1 that the UE 3 is currently registered with, the UE 3 initiates a procedure to release the RRC connection, as shown in step S4.

Specifically, if the release configuration allows the UE 3 to do so (e.g. a uEReleaseAllowedIndication IE or a uEReleaseLocationIndication IE is included in the RRCRelease message and it is set to “TRUE”), then the UE 3 triggers its own release (to RRC Idle) by sending an appropriate indication to the serving base station 6. For example, the UE 3 may send an information element (e.g. a uEReleaseIndication IE) indicating that the UE 3 is requesting RRC connection release. This information element may be included in an appropriately formatted RRCResumeRequest message. The UE 3 may also include an appropriate cause value in the RRCResumeRequest message to indicate to the network that the UE 3 is requesting release of the RRC connection due to the UE's current location (e.g. a cause value representing ‘UE Release due to location’, a cause value representing ‘UE movement into a new location/new coverage area’, a cause value representing ‘Release due to UE preference’, and/or a cause value representing ‘UE Release due to Allowance’).

Beneficially, based on the message from the UE 3 (and any information elements included therein), the network can release the associated UE context in a timely manner (in step S8). In step S9 the base station 6 confirms that the UE 3 is allowed to release its old RRC connection, by generating and sending an appropriate signalling message (e.g. an RRCRelease message).

As generally shown in step S11, the UE 3 enters the RRC Idle state only after it has indicated to the network that the UE 3 had moved to a new coverage area (or country).

The third option, which is also shown in FIG. 8, is a variation of the second option. As can be seen, steps S1 to S4, and step S8 are effectively the same as in the second option. However, in this case, when the network moves the UE 3 into the RRC Idle state, as generally shown in step S9, the base station 6 also provides appropriate redirection information for assisting the UE 3 to register with a suitable AMF that serves the UE's new coverage area. This information may comprise e.g. a list of PLMNs served by the UE's current cell and corresponding coverage areas, and/or a list of AMFs (at least one AMF) that serves the UE's current coverage area (or country).

The redirection information is included in the RRCRelease message (transmitted in step S9) and the UE 3 selects a suitable PLMN based on this information. Once the UE 3 has released its old RRC connection (step S11), the UE 3 initiates an appropriate RRC setup procedure in the new coverage area (via the base station 6) and registers with the new AMF 9-2 serving that coverage area, as shown in steps S12 and S13 of FIG. 8.

### Solution 3

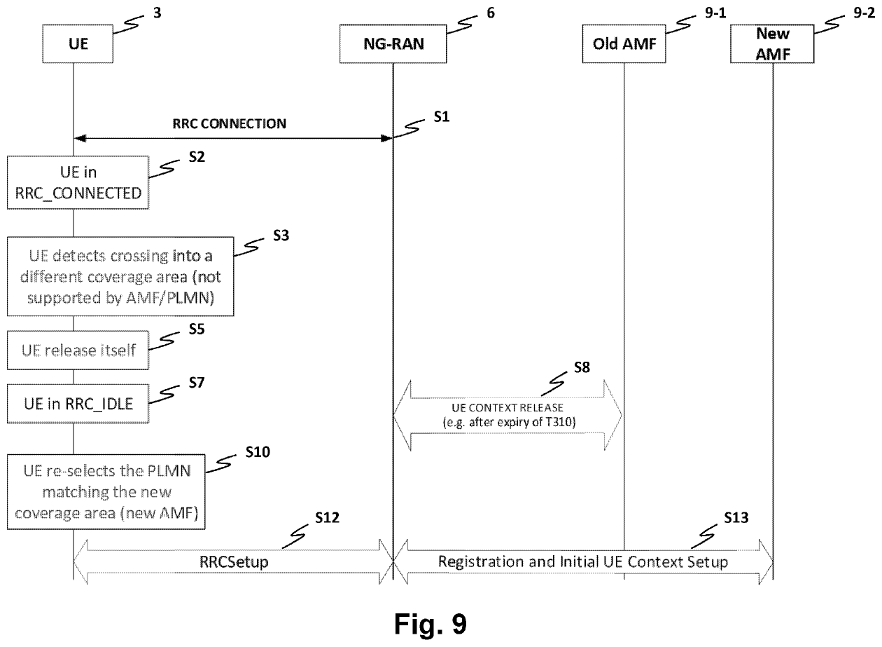

The UE 3 may be configured to release its RRC connection, or initiate a procedure to release it, even when the UE 3 is in the RRC Connected state. FIGS. 9 to 11 illustrate schematically some possible ways for releasing the UE's RRC connection when the UE 3 moves to a new coverage area (or country).

A first option of Solution 3 is illustrated in FIG. 9. This option is similar to the first option of Solution 2 described above with reference to FIG. 7. However, as generally illustrated in step S1, in this case the UE 3 has an active RRC connection with the network (e.g. a gNB of an NG-RAN), thus the UE 3 remains in the RRC Connected state (step S2). As above, the UE 3 is registered with an AMF 9-1 (denoted ‘Old AMF’ in FIG. 9) serving the UE's current coverage area. An associated UE context is maintained at the base station 6 serving the UE 3. This UE context is related to, or valid in, the coverage area (country) served by the AMF 9-1 that the UE 3 is currently registered with.

Whilst in the RRC Connected state, the UE 3 monitors its location (e.g. by performing periodic location measurements, by monitoring signal conditions of nearby cells, and/or by monitoring system information transmitted in nearby cells, including the current serving cell). In this example, the UE 3 determines its current location based using GNSS, MCC, and/or the like.

When the UE 3 detects (in step S3) that it has moved to a coverage area (a new country) other than the coverage area served by the AMF 9-1 that the UE 3 is currently registered with, the UE 3 releases the RRC connection, as generally shown in step S5. As can be seen, in this case the UE 3 releases the RRC connection on its own, without exchanging signalling messages with the network, and the UE 3 enters the RRC Idle state (step S7). It will be appreciated that both the old and the new coverage areas may be served by the same cell (e.g. ‘Cell A’ in FIG. 5).

On the network side, due to the UE 3 being in RRC Idle state (which means that the UE does not resume the RRC connection within a predetermined time and does not provide a location update), the base station 6 and the old serving AMF 9-1 perform an appropriate UE Context Release procedure (step S8) to remove the UE context associated with the UE 3 (e.g. upon the expiry of an appropriate ‘T310’ timer and/or the like).

Next, in step S10, the UE 3 determines which PLMN to use in the current coverage area, if any. As generally shown in steps S12 and S13 of FIG. 9, the UE 3 selects an appropriate PLMN and proceeds to register with a new AMF 9-2 associated with the coverage area (or country) where the UE 3 is currently located, including an appropriate RRC setup procedure in the new coverage area (via a serving base station 6). A suitable PLMN may be selected based on information held at the UE 3 (e.g. a list of PLMNs and corresponding coverage areas). It will be appreciated that the UE Context Release procedure with the base station 6 (step S8) may be performed after (or in response to) the RRC setup (step S12) or the registration of the UE 3 with the new AMF 9-2 (step S13).

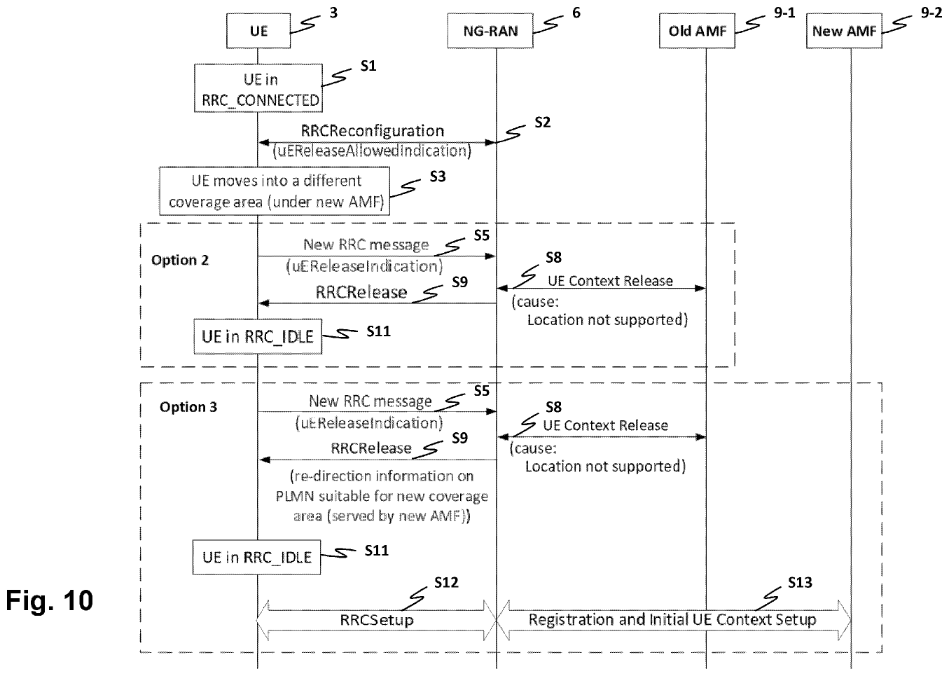

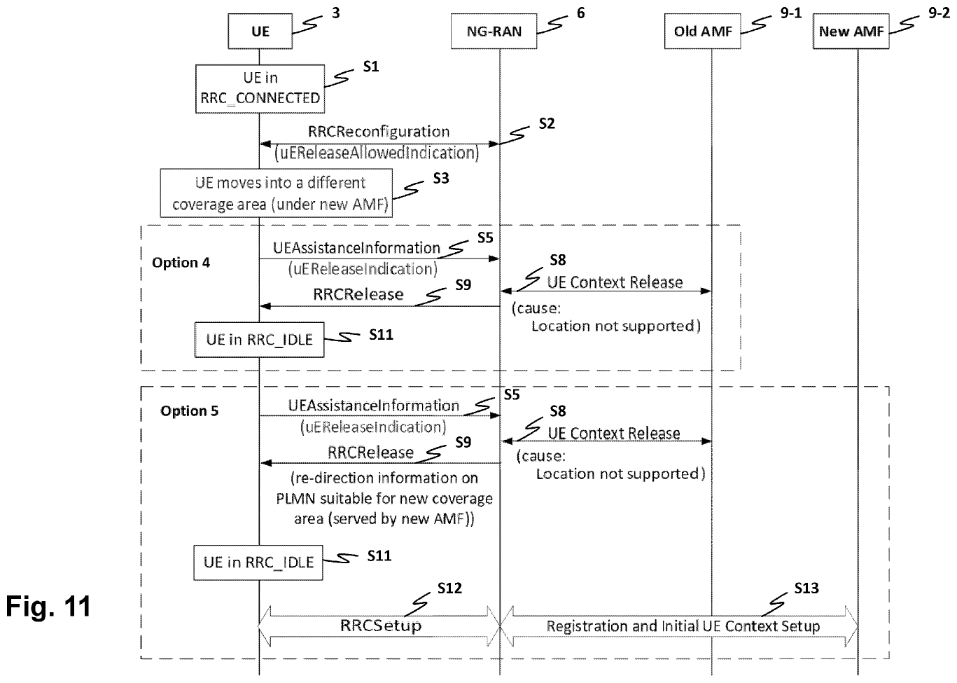

FIGS. 10 and 11 are signalling (timing) diagrams schematically illustrating some further options for moving the UE 3 from RRC Connected to RRC Idle when the UE 3 moves to a new coverage area (new country). Options 2 and 4 are similar to option 2 described above with reference to FIG. 8, and options 3 and 5 are similar to option 3 of FIG. 8. However, in FIGS. 10 and 11 the UE 3 is in RRC Connected state when it initiates a procedure to release the RRC connection.

It will be appreciated that steps S1 to S3 are common for all options illustrated in FIGS. 10 and 11. As shown in step S1, the UE 3 is initially in the RRC Connected state. Thus, the UE 3 has an RRC connection with a base station 6 (e.g. a gNB of an NG-RAN) and the UE 3 is registered with an AMF 9-1 that serves the UE's current coverage area (e.g. ‘Country X’ in FIGS. 5 and 6).

In step S2, the serving base station 6 sets the applicable UE release configuration using one or more appropriate information elements (IEs) to allow the UE 3 to release itself once it moves into (crosses the border of) a new coverage area, different to the one where the UE 3 was previously registered. In this example, the UE release configuration is sent to the UE 3 in an appropriately formatted RRCReconfiguration message. For example, the message may include a uEReleaseAllowedIndication IE or a uEReleaseLocationIndication IE, similarly to the information element included in the RRCRelease message in step S1 of FIG. 8.

The UE 3 monitors its location (at least on a coverage area level), and when the UE 3 determines (in step S3), based on its location information, and/or information identifying/relating to a border of any at least one coverage area associated with that cell, that it has moved to a different coverage area (new country) than the coverage area served by the AMF 9-1 that the UE 3 is currently registered with, the UE 3 initiates a procedure to release the RRC connection, as shown in step S5.

In Option 2, step S5 comprises sending, by the UE 3, an indication (in this case a new RRC message) that the UE 3 is releasing the RRC connection due to a change in location. Effectively, the UE 3 triggers its own release to RRC Idle state. Specifically, the UE 3 sends this indication to the serving base station 6 if the release configuration allows the UE 3 to do so (e.g. if the RRCReconfiguration message includes a uEReleaseAllowedIndication IE or a uEReleaseLocationIndication IE which is set to “TRUE”). As described above with reference to step S4 of FIG. 8, the RRC message may include an information element (e.g. a uEReleaseIndication IE) indicating that the UE 3 is requesting RRC connection release. The RRC message may also include an appropriate cause value to indicate to the network that the UE 3 is requesting release of the RRC connection due to the UE's current location (e.g. a cause value representing ‘UE Release due to location’, a cause value representing ‘UE movement into a new location/new coverage area’, a cause value representing ‘Release due to UE preference’, and/or a cause value representing ‘UE Release due to Allowance’).

Beneficially, based on the message from the UE 3 (and any information elements included therein), the network can release the associated UE context in a timely manner (in step S8). In step S9 the base station 6 confirms that the UE 3 is allowed to release its old RRC connection, by generating and sending an appropriate signalling message (e.g. an RRCRelease message).

As generally shown in step S11, the UE 3 enters the RRC Idle state only after it has indicated to the network that the UE 3 had moved to a new coverage area (or country).

Turning now to Option 3 of FIG. 10, steps S5 and S8 are the same as above. However, in this case, the base station 6 also provides appropriate redirection information for assisting the UE 3 to register with a suitable AMF that serves the UE's new coverage area. This information may comprise e.g. a list of PLMNs served by the UE's current cell and corresponding coverage areas, and/or a list of AMFs (at least one AMF) that serves the UE's current coverage area (or country).

The redirection information is included in the RRCRelease message (transmitted in step S9) and the UE 3 selects a suitable PLMN based on this information. Once the UE 3 has released its old RRC connection (step S11), the UE 3 initiates an appropriate RRC setup procedure in the new coverage area (via the base station 6) and registers with the new AMF 9-2 serving that coverage area, as shown in steps S12 and S13 of FIG. 10.

Options 4 and 5 are effectively the same as Options 2 and 3, respectively. However, as can be seen in FIG. 11, the message sent by the UE 3 in step S5 may comprise a UEAssistanceInformation message for triggering release of the RRC connection (to RRC Idle state). Effectively, using the UEAssistanceInformation message, the UE 3 is able to indicate to the network its preferred RRC state (in this case RRC Idle state).

The UE's preferred RRC state may be indicated via a preferredRRC-State information element within the UEAssistanceInformation message. The preferredRRC-State information element may be set to the value ‘idle’ when the UE 3 prefers to be released from the RRC Connected state and transition to RRC Idle state. Alternatively, the value ‘inactive’ may be indicated if the UE 3 prefers to be released from the RRC Connected state and transition to RRC Inactive state. If appropriate, the value ‘connected’ may be used if the UE prefers to revert an earlier indication to leave the RRC Connected state. The value ‘outOfConnected’ may be used to indicate if the UE 3 prefers to be released from the RRC Connected state and has no preferred RRC state to transition to. Thus, the UE's state in step S11 may depend on the UE's preference, i.e. the value of the preferredRRC-State information element.

### Benefits

The above described solutions make it possible to avoid using an unsuitable UE context in a new country or area. It is also possible to reduce signalling overhead resulting from failure in UE attempts to access the cell in the new coverage area.

### Modifications and Alternatives

Detailed example embodiments have been described above. As those skilled in the art will appreciate, a number of modifications and alternatives can be made to the above example embodiments whilst still benefiting from the inventions embodied therein. By way of illustration only a number of these alternatives and modifications will now be described.

It will be appreciated that the above example embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

Section 10.1 of 3GPP TR 38.857 V18.0.0 provides further information on positioning for UEs in RRC_INACTIVE state. In summary, the following positioning techniques have been considered:
Downlink (DL), Uplink (UL), and DL+UL positioning methods;
UE-based and UE-assisted positioning solutions;
Support of UE positioning measurements for UEs in RRC_inactive state;
Options that can be considered include Downlink Positioning Reference Signal (DL-PRS) or DL-PRS and Synchronization Signal Block (SSB);
Support of gNB positioning measurements for UEs in RRC_inactive state. In order to enable UE positioning in RRC_INACTIVE state the following techniques may be used:
UL reference signals (e.g. Sounding Reference Signal (SRS) for positioning, Physical Random Access Channel (PRACH) preambles) for UL measurements;
Signalling and procedures to support the assistance data delivery, DL-PRS configuration, UL reference signals for positioning resource configuration, measurement reporting, which may be developed based on the enhancements of existing signalling and procedures (e.g., existing 2-step and/or 4-step PRACH procedures, paging procedure, small data transmission).

The following procedures may be used for DL positioning in RRC_INACTIVE:
Reporting of DL-PRS measurement and/or location estimate performed in RRC_INACTIVE when the UE is in RRC_INACTIVE;
The reporting of DL-PRS measurement and/or location estimate performed in RRC_INACTIVE when the UE is in RRC_INACTIVE is enabled by enhancing small data transmission in RRC_INACTIVE;
On-demand system information request in RRC_INACTIVE for assistance data delivery by broadcast in RRC_INACTIVE;
ProvideAssistanceData in RRC_CONNECTED for DL-PRS configuration used in RRC_INACTIVE downlink positioning;
RequestLocationInformation can be sent in RRC_CONNECTED for DL-PRS measurement or location estimate performed in RRC_INACTIVE.

It will be appreciated that the UE may be configured to derive its location using any of the above techniques.

In the above description, the RRCRelease message and the RRCReconfiguration message include a uEReleaseAllowedIndication IE or a uEReleaseLocation Indication IE to indicate to the UE that it is allowed to release the RRC connection upon crossing a border. However, it will be appreciated that the release configuration may be provided using any other suitable message and/or any other suitable information element.

### [Table 1]

TABLE 1
types of satellites and UAS platforms

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Earth Orbit | 7000-25000 | km | | 100-1000 | km |
| (MEO) satellite | | | | | |
| Geostationary Earth | 35 786 | km | Notional station keeping | 200-3500 | km |
| Orbit (GEO) satellite | | | position fixed in terms of | | |
| UAS platform | 8-50 km | | elevation/azimuth with | 5-200 | km |
| (including HAPS) | (20 km for HAPS) | | respect to a given earth point | | |
| High Elliptical Orbit | 400-50000 | km | Elliptical around the earth | 200-3500 | km |

(HEO) satellite

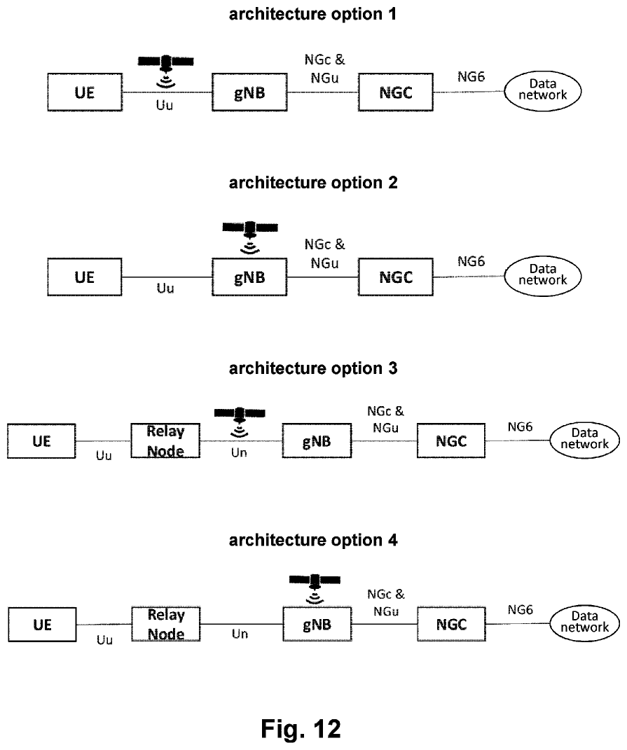

It will be appreciated that there are various architecture options to implement NTN in a 5G system, some of which are illustrated schematically in FIG. 12. The first option shown is an NTN featuring an access network serving UEs and based on a satellite/aerial with bent pipe payload and gNB on the ground (satellite hub or gateway level). The second option is an NTN featuring an access network serving UEs and based on a satellite/aerial with gNB on board. The third option is an NTN featuring an access network serving Relay Nodes and based on a satellite/aerial with bent pipe payload. The fourth option is an NTN featuring an access network serving Relay Nodes and based on a satellite/aerial with gNB. It will be appreciated that other architecture options may also be used, for example, a combination of two or more of the above described options. Alternatively, the relay node may comprise a satellite/UAS.

In the above description, the UE, the NTN node (satellite/UAS platform), and the access network node (base station) are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above example embodiments are also applicable to ‘non-mobile’ or generally stationary user equipment. The above described mobile device may comprise an MTC/IoT device and/or the like.

The method performed by the UE may further comprise acquiring information identifying at least one Public Land Mobile Network (PLMN) and/or at least one Mobile Country Code (MCC) relating to at least one respective coverage area served by a current cell of the UE; and determining that a current location of the UE is in a different coverage area to the first coverage area based on the acquired information (e.g. system information).

The method performed by the UE may further comprise obtaining information relating to a border of at least one coverage area served by a current cell of the UE; and determining that a current location of the UE is in a different coverage area to the first coverage area based on the information relating to said border.

The method performed by the UE may further comprise receiving information (e.g. a ‘uEReleaseAllowedIndication’ or a ‘uEReleaseLocationIndication’ information element) indicating that the UE is allowed to release the RRC connection based on the location of the UE. The information may be received in an RRCRelease message or an RRCReconfiguration message.

The releasing the RRC connection may comprise sending, by the UE to the network node, information indicating at least one of: the UE is requesting RRC connection release (e.g. using a uEReleaseIndication information element); and a preferred RRC state (e.g. using a preferredRRC-State information element). The information may be included in an RRC message (e.g. a RRCResumeRequest message or a UEAssistanceInformation message). The information may include a cause value indicating a reason for releasing the RRC connection (e.g. a cause value representing ‘UE Release due to location’; a cause value representing ‘UE movement into a new location/new coverage area’; a cause value representing ‘Release due to UE preference’; and/or a cause value representing ‘UE Release due to Allowance’).

The method performed by the UE may further comprise setting up an RRC connection via a cell serving the different coverage area and selecting a PLMN and/or a core network node for mobility management associated with that coverage area based on a list of PLMNs and corresponding coverage areas held by the UE.

The method performed by the UE may further comprise receiving information for redirecting the UE to a PLMN and/or a core network node for mobility management associated with the location of the UE and setting up an RRC connection via a cell serving the different coverage area based on the information for redirecting the UE. The method may comprise receiving an RRCRelease message or an RRCReject message comprising said information for redirecting the UE to an AMF/PLMN associated with the location of the UE.

The determining that a current location of the UE is in a different coverage area to the first coverage area may be based on at least one of a Global Navigation Satellite System (GNSS) based location and a MCC associated with the UE.

The method performed by the network node may further comprise triggering release of a UE context related to the first coverage area after receiving the message from the UE.

The method performed by the network node may further comprise transmitting information identifying at least one Public Land Mobile Network (PLMN) and/or at least one Mobile Country Code (MCC) relating to at least one respective coverage area served by a cell of the network node.

The method performed by the network node may further comprise transmitting, to the UE, information relating to a border of at least one coverage area served by the cell of the network node.

The method performed by the network node may further comprise transmitting, to the UE, information (e.g. in an RRCRelease message or an RRCReconfiguration message, using a ‘uEReleaseAllowedIndication’ or a ‘uEReleaseLocationIndication’ information element) indicating that the UE is allowed to release the RRC connection based on the location of the UE.

The method performed by the network node may further comprise transmitting, to the UE, information for redirecting the UE to a PLMN and/or a core network node for mobility management associated with the location of the UE.

The method performed by the network node may comprise transmitting, to the UE, an RRCRelease message or an RRCReject message comprising said information for redirecting the UE to an AMF/PLMN associated with the location of the UE.

The RRC connection related to the first coverage area may be a suspended RRC connection or an active RRC connection.

Various other modifications will be apparent to those skilled in the art and will not be described in further detail here.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

This application is based upon and claims the benefit of priority from United Kingdom patent application No. 2105402.8, filed on Apr. 15, 2021 and United Kingdom patent application No. 2106477.9, filed on May 6, 2021, the disclosure of which is incorporated herein in its entirety by reference.

### Supplementary Note

The whole or part of the example embodiments disclosed above can be described as, but not limited to, the following supplementary notes.

### (Supplementary Note 1)

A method performed by a user equipment (UE) configured to communicate via a non-terrestrial network including a plurality of cells, wherein the UE has a Radio Resource Control (RRC) connection related to a first coverage area, the method comprising:
determining that a current location of the UE is in a different coverage area to the first coverage area; and
releasing the RRC connection based on the current location of the UE.

### (Supplementary Note 2)

The method according to supplementary note 1, further comprising:

acquiring first information identifying at least one Public Land Mobile Network (PLMN) and/or at least one Mobile Country Code (MCC) relating to at least one respective coverage area served by a current cell of the UE, wherein
the determining is performed based on the first information.

### (Supplementary Note 3)

The method according to supplementary note 1 or 2, further comprising: obtaining second information relating to a border of at least one coverage area served by a current cell of the UE, wherein the determining is performed based on the second information.

### (Supplementary Note 4)

The method according to any of supplementary notes 1 to 3, further comprising receiving third information indicating that the UE is allowed to release the RRC connection based on the location of the UE.

### (Supplementary Note 5)

The method according to supplementary note 4, wherein the third information is included in an RRCRelease message or an RRCReconfiguration message.

### (Supplementary Note 6)

The method according to any of supplementary notes 1 to 5, wherein the releasing the RRC connection includes sending, to the network node, fourth information indicating at least one of: the UE is requesting RRC connection release; and a preferred RRC state.

### (Supplementary Note 7)

The method according to supplementary note 6, wherein the fourth information is included in an RRC message.

### (Supplementary Note 8)

The method according to supplementary note 6 or 7, wherein the fourth information includes a cause value indicating a reason for releasing the RRC connection.

### (Supplementary Note 9)

The method according to any of supplementary notes 1 to 8, further comprising: setting up an RRC connection via a cell serving the different coverage area; and selecting a PLMN and/or a core network node for mobility management associated with the coverage area based on a list of PLMNs and corresponding coverage areas held by the UE.

### (Supplementary Note 10)

The method according to any of supplementary notes 1 to 8, further comprising:
receiving fifth information for redirecting the UE to a PLMN and/or a core network node for mobility management associated with the location of the UE; and
setting up an RRC connection via a cell serving the different coverage area based on the information for redirecting the UE.

### (Supplementary Note 11)

The method according to supplementary note 10, comprising receiving an RRCRelease message or an RRCReject message including the fifth information.

### (Supplementary Note 12)

The method according to any of supplementary notes 1 to 11, wherein the determining that the current location of the UE is in a different coverage area to the first coverage area is based on at least one of a Global Navigation Satellite System (GNSS) based location and a MCC associated with the UE.

### (Supplementary Note 13)

A method performed by a network node configured to communicate with a user equipment (UE) via a non-terrestrial network including a plurality of cells, wherein the UE has a Radio Resource Control (RRC) connection related to a first coverage area, the method comprising:
receiving, from the UE, a first message initiating a procedure for releasing the RRC connection based on the current location of the UE; and
transmitting, to the UE, a second message releasing the RRC connection based on the location of the UE.

### (Supplementary Note 14)

The method according to supplementary note 13, further comprising triggering release of a UE context related to the first coverage area after receiving the first message from the UE.

### (Supplementary Note 15)

The method according to supplementary note 13 or 14, further comprising transmitting first information identifying at least one Public Land Mobile Network (PLMN) and/or at least one Mobile Country Code (MCC) relating to at least one respective coverage area served by a cell of the network node.

### (Supplementary Note 16)

The method according to any of supplementary notes 13 to 15, further comprising transmitting, to the UE, second information relating to a border of at least one coverage area served by the cell of the network node.

### (Supplementary Note 17)

The method according to any of supplementary notes 13 to 16, further comprising transmitting, to the UE, third information indicating that the UE is allowed to release the RRC connection based on the location of the UE.

### (Supplementary Note 18)

The method according to any of supplementary notes 13 to 17, wherein the first message includes fourth information indicating at least one of: the UE is requesting RRC connection release; and a preferred RRC state.

### (Supplementary Note 19)

The method according to supplementary note 18, wherein the fourth information is included in an RRC message.

### (Supplementary Note 20)

The method according to supplementary note 18 or 19, wherein the fourth information includes a cause value indicating a reason for releasing the RRC connection.

### (Supplementary Note 21)

The method according to any of supplementary notes 13 to 20, further comprising transmitting, to the UE, fifth information for redirecting the UE to a PLMN and/or a core network node for mobility management associated with the location of the UE.

### (Supplementary Note 22)

The method according to supplementary note 21, comprising transmitting, to the UE, an RRCRelease message or an RRCReject message comprising the fifth information.

### (Supplementary Note 23)

A user equipment (UE) configured to communicate via a non-terrestrial network including a plurality of cells, wherein the UE has a Radio Resource Control (RRC) connection related to a first coverage area, the UE comprising: means for determining that a current location of the UE is in a different coverage area to the first coverage area; and means for releasing the RRC connection based on the current location of the UE.

### (Supplementary Note 24)

A network node configured to communicate with a user equipment (UE) via a non-terrestrial network including a plurality of cells, wherein the UE has a Radio Resource Control (RRC) connection related to a first coverage area, the network node comprising:
means for receiving, from the UE, a message initiating a procedure for releasing the RRC connection based on the current location of the UE; and
means for transmitting, to the UE, a message releasing the RRC connection based on the location of the UE.

### (Supplementary Note 25)

A computer-readable non-transitory storage medium storing a program, wherein the program is executed by a user equipment (UE) configured to communicate via a non-terrestrial network including a plurality of cells, the UE having a Radio Resource Control (RRC) connection related to a first coverage area;
the program causes the UE to execute:
determining that a current location of the UE is in a different coverage area to the first coverage area; and
releasing the RRC connection based on the current location of the UE.

### (Supplementary Note 26)

A computer-readable non-transitory storage medium storing a program, wherein the program is executed by a network node configured to communicate with a user equipment (UE) via a non-terrestrial network including a plurality of cells, the UE having a Radio Resource Control (RRC) connection related to a first coverage area;
the program causes the network node to execute:
receiving, from the UE, a message initiating a procedure for releasing the RRC connection based on the current location of the UE; and
transmitting, to the UE, a message releasing the RRC connection based on the location of the UE.

### REFERENCE SIGNS LIST

1 mobile telecommunication system
3 user equipment
5 satellite
6 gateway
7 data network

What is claimed is:

1. A method performed by a user equipment (UE) configured to communicate via a non-terrestrial network, the method comprising:
receiving a message for suspending a Radio Resource Control (RRC) connection related to a first coverage area;
determining that a current location of the UE is in a different coverage area from the first coverage area; and
releasing the suspended RRC connection based on the current location of the UE.

2. The method according to claim 1, further comprising:
obtaining first information identifying at least one a Public Land Mobile Network (PLMN) and/or a Mobile Country Code (MCC) relating to the different coverage area, wherein
the determining is performed based on the first information.

3. The method according to claim 1, further comprising:
obtaining second information relating to a border of the different coverage area, wherein
the determining is performed based on the second information.

4. The method according to claim 1, further comprising receiving third information indicating that the UE is allowed to release the suspended RRC connection based on the current location of the UE.

5. The method according to claim 4, wherein the third information is included in an RRCRelease message or an RRCReconfiguration message.

6. The method according to claim 1, wherein the releasing the suspended RRC connection includes sending, to a network node, fourth information indicating at least one of:
the UE is requesting RRC connection release; and
a preferred RRC state.

7. The method according to claim 6, wherein the fourth information is included in an RRC message.

8. The method according to claim 6, wherein the fourth information includes a cause value indicating a reason for releasing the suspended RRC connection.

9. The method according to claim 1, further comprising:
setting up another RRC connection via a cell serving the different coverage area; and
selecting a PLMN and/or a core network node for mobility management associated with the different coverage area based on a list of PLMNs and corresponding coverage areas held by the UE.

10. The method according to claim 1, further comprising:
receiving fifth information for redirecting the UE to a PLMN and/or a core network node for mobility management associated with the current location of the UE; and
setting up another RRC connection via a cell serving the different coverage area based on the fifth information.

11. The method according to claim 10, wherein
the fifth information is included in an RRCRelease message or an RRCReject message.

12. The method according to claim 1, wherein
the determining that the current location of the UE is in the different coverage area to from the first coverage area is based on at least one of:
a Global Navigation Satellite System (GNSS) based location; and
a MCC associated with the UE.

13. A method performed by a network node configured to communicate with a user equipment (UE) via a non-terrestrial network, the method comprising:
transmitting, to the UE, a message for suspending a Radio Resource Control (RRC) connection related to a first coverage area;
receiving, from the UE, a first message initiating a procedure for releasing the suspended RRC connection based on a current location of the UE; and
transmitting, to the UE, a second message releasing the suspended RRC connection based on the current location of the UE.

14.-22. (canceled)

23. A user equipment (UE) configured to communicate via a non-terrestrial network, the UE comprising:
a memory storing instructions; and
at least one processor configured to process the instructions to:
receive a message for suspending a Radio Resource Control (RRC) connection related to a first coverage area;
determine that a current location of the UE is in a different coverage area from the first coverage area; and
release the suspended RRC connection based on the current location of the UE.

24. A network node configured to communicate with a user equipment (UE) via a non-terrestrial network, the network node comprising:
a memory storing instructions; and
at least one processor configured to process the instructions to:
transmit, to the UE, a message for suspending a Radio Resource Control (RRC) connection related to a first coverage area;
receive, from the UE, a message initiating a procedure for releasing the suspended RRC connection based on a current location of the UE; and
transmit, to the UE, a message releasing the suspended RRC connection based on the current location of the UE.

25.-26. (canceled)
